(19) United States
(12) Patent Application Publication
(10) Pub. No.: US 2014/0105721 A1
(43) Pub. Date: Apr. 17, 2014

(54) OPTIMIZED MASS FLOW THROUGH A MULTI STAGED DUCT SYSTEM GUIDE VANE OF A WIND TURBINE

(71) Applicant: Dan Koko, Tustin, CA (US)

(72) Inventor: Dan Koko, Tustin, CA (US)

(21) Appl. No.: 14/056,743

(22) Filed: Oct. 17, 2013

Related U.S. Application Data
(60) Provisional application No. 61/714,967, filed on Oct. 17, 2012.

(51) Int. Cl. F03D 1/06

(52) U.S. Cl. CPC F03D 1/06
USPC 415/1; 415/68

(57) ABSTRACT

A multi-stage duct system adaptable to generate maximum power from a wind turbine is presented. The multi-stage duct system comprises a plurality of wind turbine units. Each of the plurality of wind turbine units includes a plurality of turbine rings and a plurality of airfoils. The plurality of turbine rings defines to form a plurality of expanding stages and a plurality of contracting stages positioned in-line with a fluid flow direction. The multi-stage duct system further comprises a duct analysis unit having a plurality of axisymmetric ducts. The duct analysis unit utilizes a fluid dynamics mechanism to provide an optimal airfoil arrangement to the plurality of airfoils. The optimal airfoil arrangement optimizes a plurality of airfoil parameters associated with each of the plurality of airfoils thereby providing an efficient diffusion and an optimal fluid mass flow rate through the plurality of airfoils.

### CROSS-REFERENCE TO RELATED APPLICATIONS

This application claims the benefit of U.S. Provisional Application No. 61/714,967 filed Oct. 17, 2012.

### STATEMENT REGARDING FEDERALLY SPONSORED RESEARCH AND DEVELOPMENT

Not Applicable.

### FIELD OF THE DISCLOSURE

This embodiment relates to design and modifications of airfoils, and more particularly to an improved design for the gap and overlap of airfoils used in a multi-staged duct system of a wind turbine for getting optimized fluid mass flow rate and power output.

### DISCUSSION OF RELATED ART

Wind turbines have widely been used to convert wind energy to electrical energy. The existing wind turbines for electrical power generation are horizontal axis wind turbines. The horizontal wind turbines employ long airfoils attached to a rotor hub. The airfoils rotate using the wind energy that forces the rotor hub to rotate in a rotor axis that is parallel to the ground.

Improvements have been applied to conventional wind turbine blades or airfoils to obtain maximum airflow and increased rotation of the rotor hub to generate more energy. The conventional wind turbine designs concentrated primarily toward the design of the airfoils. These improvements in design are mainly dependent on the shape of the airfoil and the pitch angle of the airfoil. The shape of these airfoils is modified to achieve greater rotation, and thus increased efficiency of the wind turbine.

Some other design improvements include systems to rotate the blade about the longitudinal axis of the blade to dynamically vary the pitch angles of the airfoil in an attempt to avoid stall conditions for the airfoil. Continuous monitoring of the wind speed and the pitch angle of the airfoils permits the pitch angle to be continuously varied in an attempt to match the pitch angle to the wind speed and thereby avoid stalling and thus maximize the kinetic energy extracted from the wind. The pitch angles are limited to vary within a certain limited range to avoid stalling. These effective pitch angles' limits resulted only in reduced power output. However, the variable pitch systems control the revolutions per minute (RPMs) of the electrical generator. But an alternating current generator must turn at the exact revolutions of the cycles of the alternating current in the electrical grid into which the electricity is being utilized. Moreover, off cycle electricity is useless and harmful to the system. Further, variable pitch systems are complicated, expensive and require high maintenance cost.

Furthermore, it has been found that the airfoil designs of most existing wind turbines have a relatively high cut in wind speed, which is the lowest speed at which the force of the wind acting on the airfoil overcomes factors such as starting friction or inertia and begins producing usable power. Typically, the high cut-in wind speed is about 8 miles per hour or higher. It means that wind speed lower than about 8 miles per hour does not result in power generation, resulting in an overall inefficiency of the wind turbine.

Accordingly, none of the existing wind turbines has been designed with the objective to decrease the variations of the aerodynamic loads in stall, to effectively utilize the fluid flow rate through the airfoils in different stages and thereby to increase the overall power generation. It is essential that certain modifications should be performed for the existing airfoil sections or blades applied in wind turbine applications; because many existing wind turbines suffers the problems of poor power quality, high fatigue loads, aerodynamically induced vibrations and/or unreliability of power and loads for wind turbines operating at high wind speeds.

Therefore, there is a need for a new design for the wind turbine blades that results in optimum power quality without affecting any aerodynamically induced vibrations. The new design of the airfoils would be able to utilize the fluid flow effectively to generate more power. The fluid flow would be utilized by the airfoils in stages for obtaining efficient diffusion and increased mass flow. Such an airfoil design would be less complicated and compact. Moreover, the needed device would possess properly arranged airfoils for utilizing the fluid flow effectively. The present disclosure accomplishes these objectives.

### SUMMARY OF THE DISCLOSURE

The present embodiment is a multi-stage duct system for use in a wind turbine. The multi-stage duct system addresses a two stage duct system and analyzes the fluid mass flow rate through vanes of the wind turbine. The multi-stage duct system comprises a plurality of wind turbine units. Each of the plurality of wind turbine units includes a plurality of turbine rings. The plurality of turbine rings is designed to rotate around a central rotation axis and is secured inside a nacelle of the wind turbine. The plurality of turbine rings defines to form a plurality of expanding stages and a plurality of contracting stages positioned in-line with a fluid flow direction. Each of the plurality of turbine rings includes a plurality of airfoils. The multi-stage duct system is adaptable to generate a maximum power from a wind turbine.

The plurality of turbine rings is implemented with a magnetic mechanism having a plurality of permanent magnet alternators (PMAs) adaptable to generate more power from the wind turbine. The multi-stage duct system further comprises a duct analysis unit having a plurality of axisymmetric ducts. The duct analysis unit utilizes a fluid dynamics mechanism to provide an optimal airfoil arrangement to the plurality of airfoils. The optimal airfoil arrangement optimizes a plurality of airfoil parameters associated with each of the plurality of airfoils thereby providing an efficient diffusion and an optimal fluid mass flow rate through the plurality of airfoils. The plurality of airfoil parameters includes an airfoil overlap length, an airfoil gap length and an airfoil chord angle. The optimal airfoil arrangement compresses the fluid flow through the plurality of expanding stages and the plurality of contracting stages.

In the preferred embodiment, a two dimensional potential flow investigation is performed to support the fluid dynamics mechanism. The results of the two dimensional potential flow investigation are provided to the duct analysis unit. The fluid dynamics mechanism may be an axisymmetric Computational Fluid dynamics (CFD) study adaptable to determine the effect of gap and overlap between the airfoils of a two stage duct system. The fluid first passes through the expanding stage, producing power and then passes through the contracting stage thereby obtaining maximum power utilizing the wind energy optimally.

The CFD mechanism prepares a geometry test matrix in which different geometrical positions of airfoils are considered. These different geometrical positions are decided by changing the corresponding airfoil chord angle, airfoil overlap length between adjacent airfoils and airfoil gap length between the adjacent airfoils. By changing the parameters, like the airfoil chord angle, the airfoil overlap length and the airfoil gap length between the adjacent airfoils, design variations can be obtained. Then the simulation results of various designs are compared to decide an optimal design for the airfoils of the multi-staged wind turbine.

The two staged duct design considered for the CFD analysis has a first duct and a second duct. During simulation, the CFD models for each geometry are analyzed at a free stream velocity of 12 m/s assuming a turbulent incompressible flow. The turbulent incompressible flow employs a two-equation turbulence model of the k-ε RNG (Renormalization Group method) type. The k-ε RNG turbulence model is assumed to have a characteristic turbulence intensity of 1%. The simulation program provides a velocity and static pressure contour plots overlaid with streamlines for the selected geometrical position of adjacent airfoils to illustrate flow paths.

By selecting a duct that maximizes the mass flow rate passing through the duct/rotor system increases the mechanical power extraction of the system. The mass flow rate and power available in both ducts of the two-stage duct system are plotted. By inspecting the plots, the configuration providing the maximum fluid mass flow rate through the first stage is found out. The increased chord angles yield more diffusion, however, for arrangements with large gaps and spacing, the viscosity of the air will have a tendency to induce separation thereby trashing any performance gains. By providing a large airfoil overlap length and a small airfoil gap length, the flow is less prone to separation through the bypass allowing for more efficient diffusion and increased mass flow. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of a multi-stage duct system in accordance with a preferred embodiment of the present invention;

FIG. 2 is a perspective view of another embodiment of the multi-stage duct system of the present invention, illustrating a wind turbine unit;

FIG. 3 is a front view of the multi-stage duct system of the present invention shown in FIG. 2, illustrating the wind turbine unit;

FIGS. 4 and 5 show perspective views of the multi-stage duct system of the present invention shown in FIG. 2, illustrating a base plate assembly;

FIG. 6 is a side view of the multi-stage duct system of the present invention shown in FIG. 2, illustrating the base plate assembly;

FIG. 7A is a front view of the multi-stage duct system shown in FIG. 3, illustrating a forward nacelle;

FIG. 7B is a cross-sectional view of the multi-stage duct system of the present invention shown in FIG. 2, illustrating the wind turbine unit;

FIG. 7C is a cross-sectional view of the multi-stage duct system of the present invention shown in FIG. 7A, illustrating the forward nacelle;

FIG. 8 illustrates a two stage axisymmetric duct system having a first airfoil and a second airfoil in accordance with a preferred embodiment of the present invention;

FIG. 9A illustrates a velocity magnitude contour plot of a fluid mass flow rate over the first airfoil and the second airfoil for an airfoil design [30-10_{—}10-10] according to the preferred embodiment of the present invention;

FIG. 9B illustrates a static pressure contour plot of the fluid mass flow rate over the first airfoil and the second airfoil for the airfoil design [30-10_{—}10-10] according to the preferred embodiment of the present invention;

FIG. 10A illustrates a velocity magnitude contour plot of a fluid mass flow rate over the first airfoil and the second airfoil for an airfoil design [30-50_{—}10-10] according to the preferred embodiment of the present invention;

FIG. 10B illustrates a static pressure contour plot of the fluid mass flow rate over the first airfoil and the second airfoil for the airfoil design [30-50_{—}10-10] according to the preferred embodiment of the present invention;

FIG. 11A illustrates a velocity magnitude contour plot of a fluid mass flow rate over the first airfoil and the second airfoil for an airfoil design [30-05_{—}10-10] according to the preferred embodiment of the present invention;

FIG. 11B illustrates a static pressure contour plot of the fluid mass flow rate over the first airfoil and the second airfoil for the airfoil design [30-05_{—}10-10] in accordance with the preferred embodiment of the present invention;

FIG. 12A illustrates a velocity magnitude contour plot of a fluid mass flow rate over the first airfoil and the second airfoil for an airfoil design [30-30_{—}20-10] in accordance with the preferred embodiment of the present invention;

FIG. 12B illustrates a static pressure contour plot of the fluid mass flow rate over the first airfoil and the second airfoil for the airfoil design [30-30_{—}20-10] according to the preferred embodiment of the present invention;

FIG. 13A illustrates a velocity magnitude contour plot of a fluid flow over the first airfoil and the second airfoil for an airfoil design [50-20_{—}20-20] in accordance with the preferred embodiment of the present invention;

FIG. 13B illustrates a static pressure contour plot of the fluid mass flow rate over the first airfoil and the second airfoil for the airfoil design [50-20_{—}20-20] in accordance with the preferred embodiment of the present invention;

FIG. 14 illustrates a graph in two dimensions representing the value of the fluid mass flow rate through a first duct according to the preferred embodiment of the present invention;

FIG. 15 illustrates a graph in two dimensions representing the value of the fluid mass flow rate through a second duct according to the preferred embodiment of the present invention;

FIG. 16 illustrates a graph in two dimensions representing the value of power available at a throat of the first duct according to the preferred embodiment of the present invention; and

FIG. 17 illustrates a graph in two dimensions representing the value of power available at the throat of the second duct according to the preferred embodiment of the present invention.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

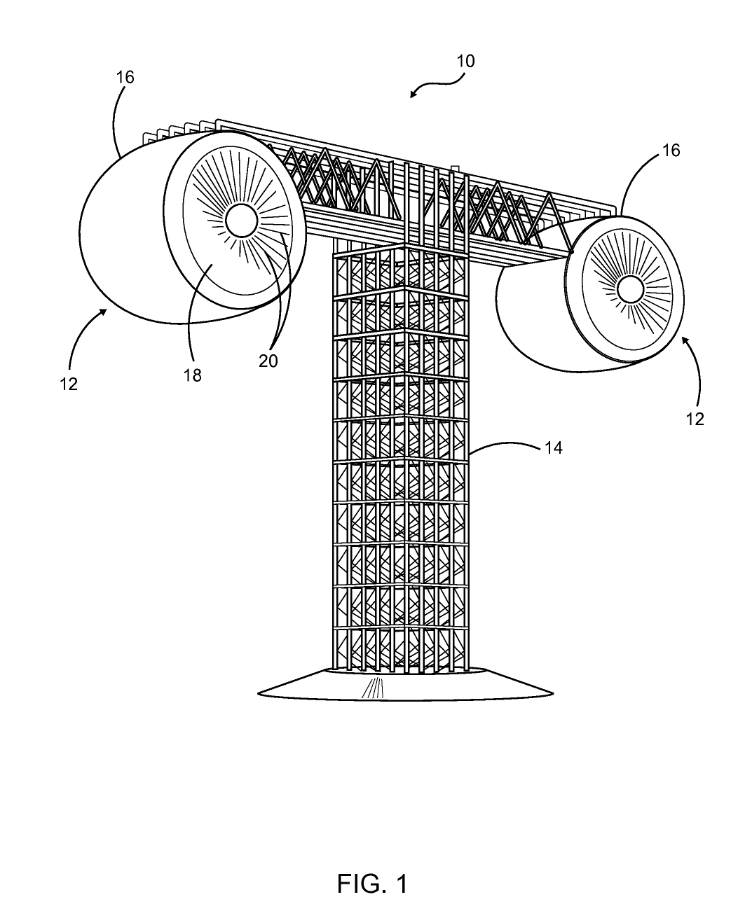

As shown in FIG. 1, a perspective view of a multi-stage duct system 10 in accordance with a preferred embodiment of the present invention is illustrated. The multi-stage duct system 10 is adaptable to generate a maximum power from a wind turbine. The multi-stage duct system 10 comprises a plurality of wind turbine units 12. Each of the plurality of wind turbine units 12 includes a plurality of turbine rings 18. The plurality of turbine rings 18 is designed to rotate around a central rotation axis and is secured inside a nacelle 16 of the wind turbine. The plurality of turbine rings 18 defines to form a plurality of expanding stages and a plurality of contracting stages positioned in-line with a fluid flow direction. The plurality of wind turbine units 12 is supported by a tower 14 to provide ground level support to the multi-stage duct system 10.

Each of the plurality of turbine rings 18 includes a plurality of airfoils 20. The plurality of turbine rings 18 is implemented with a magnetic mechanism. The magnetic mechanism features a plurality of permanent magnet alternators (PMAs) adaptable to generate more power from the wind turbine. Each of the plurality of turbine rings 18 includes a PMA. Each PMA generates electric power ranging from 1.5-7.5 MW. Preferably, the magnetic mechanism is attached outside of the plurality of turbine rings 18 and inside of the nacelle 16 to create more torque on a shaft portion of the PMA.

The multi-stage duct system 10 further comprises a duct analysis unit having a plurality of axisymmetric ducts. The duct analysis unit utilizes a fluid dynamics mechanism to provide an optimal airfoil arrangement to the plurality of airfoils 20. The optimal airfoil arrangement optimizes a plurality of airfoil parameters associated with each of the plurality of airfoils 20. The plurality of airfoil parameters includes an airfoil overlap length, an airfoil gap length and an airfoil chord angle. The optimal airfoil arrangement compresses the fluid flow through the plurality of expanding stages and the plurality of contracting stages thereby providing an efficient diffusion and an optimal fluid mass flow rate through the plurality of airfoils 20.

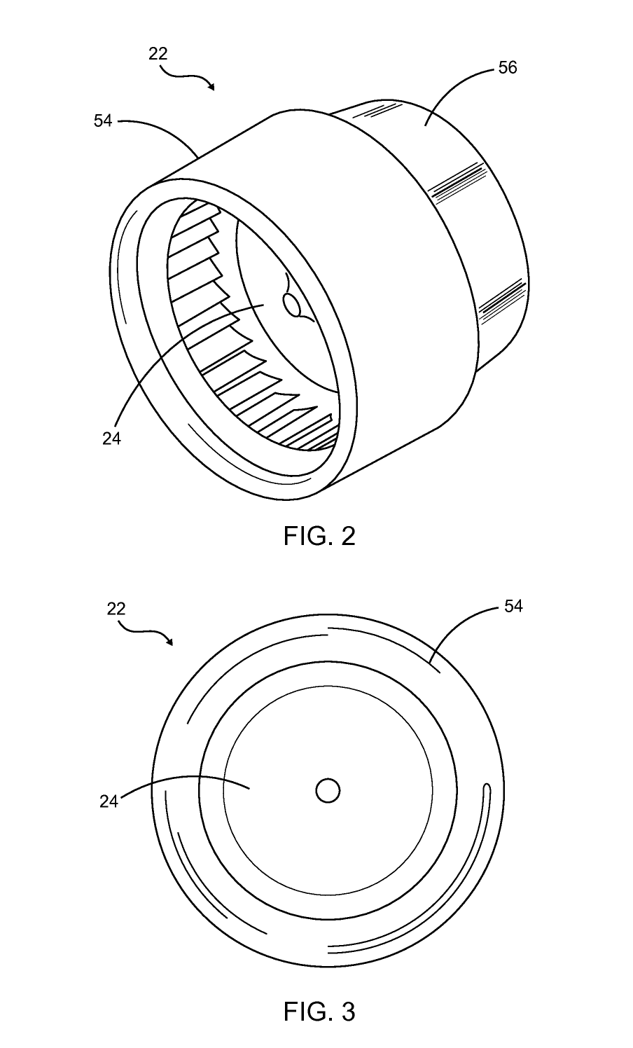

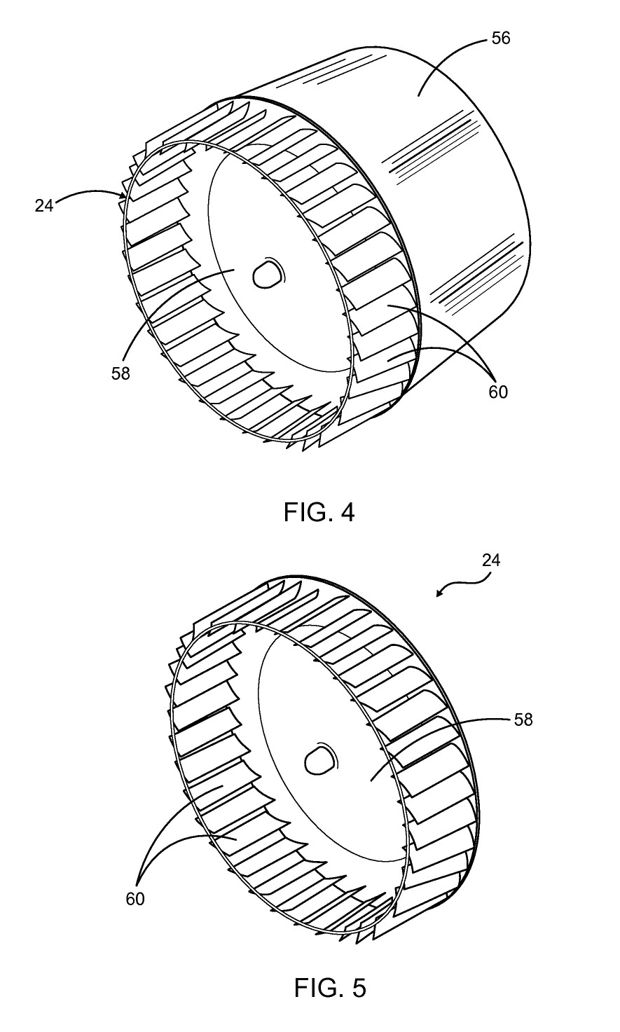

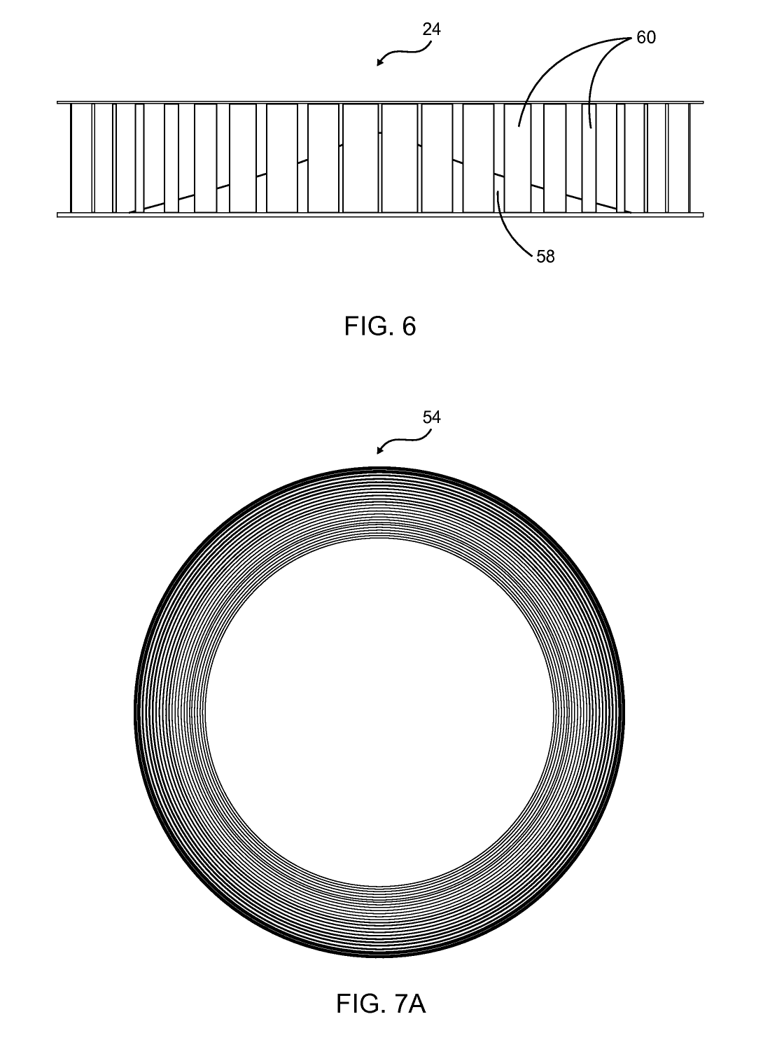

Referring to FIGS. 2-6, another embodiment of the plurality of wind turbine units 22 is illustrated. FIG. 2 shows a perspective view of the wind turbine unit 22 and FIG. 3 is a front view of the wind turbine unit 22. The wind turbine unit 22 comprises a forward nacelle 54, a rear nacelle 56, and a base plate assembly 24. FIGS. 4 and 5 show perspective views of the base plate assembly 24. The base plate assembly 24 further comprises a circular base plate 58 and a plurality of blades 60 arranged along the circumference of the base plate 58. FIG. 6 shows a side view of the base plate assembly 24. The base plate assembly 24 is designed to rotate around a central rotation axis.

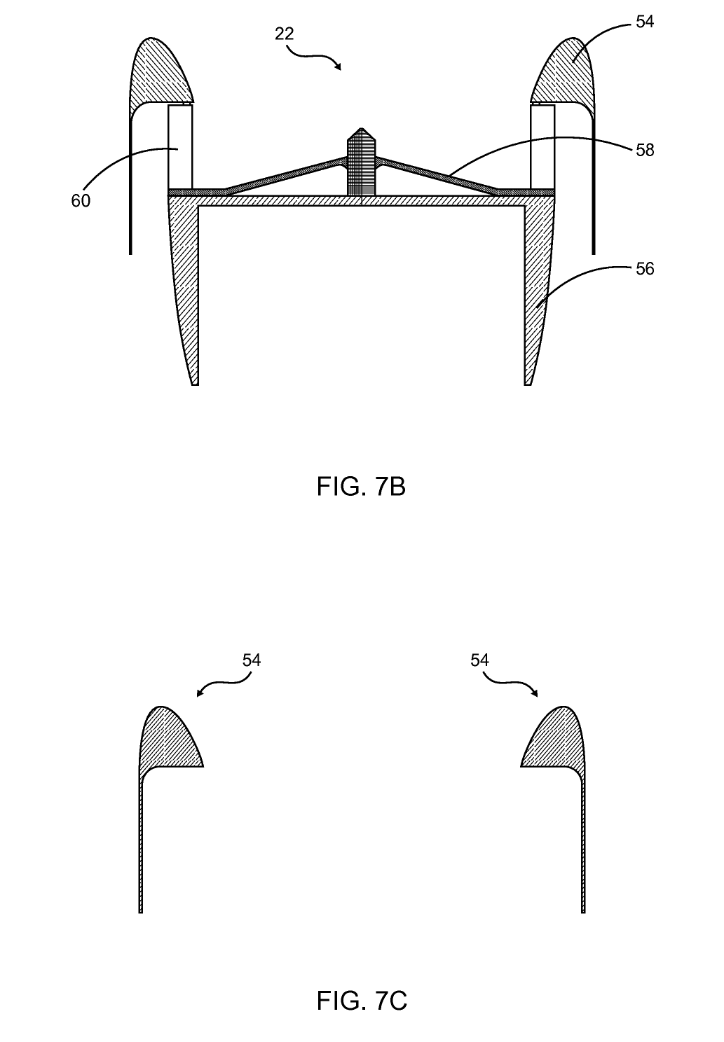

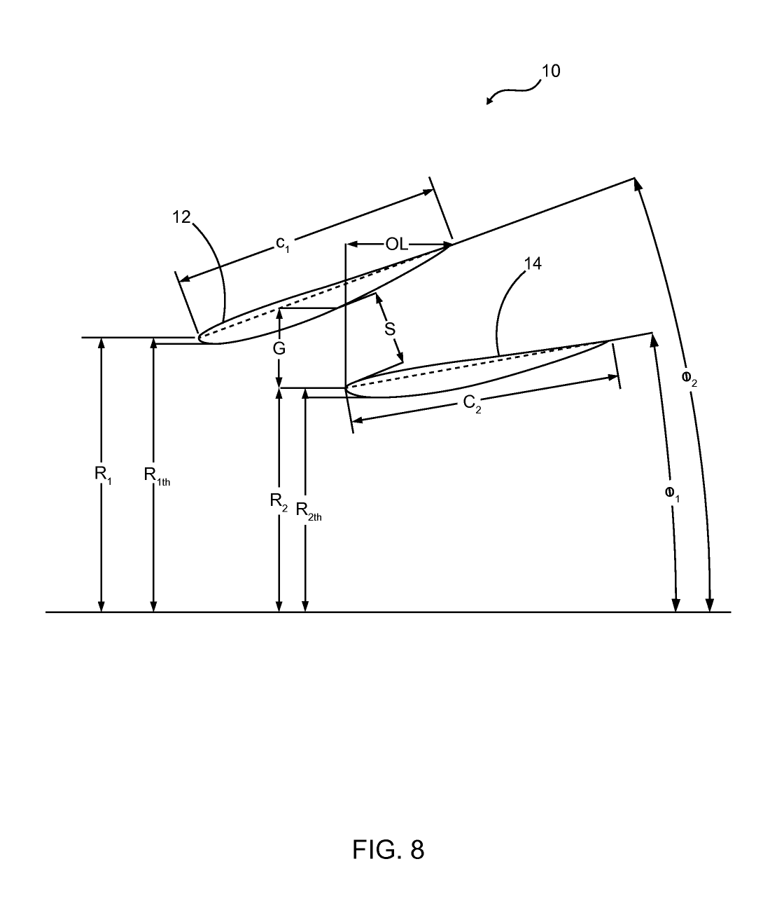

FIG. 7A shows a front view of the forward nacelle 54 of the wind turbine unit 22 of the multi-stage duct system shown in FIG. 3. FIG. 7C is a cross-sectional view of the forward nacelle 54 of the wind turbine unit 22 of the multi-stage duct system of the present invention shown in FIG. 7A. The forward nacelle 54 encases the plurality of blades 60 of the base plate assembly 24. FIG. 7B is a cross-sectional view of the wind turbine unit 22 of the multi-stage duct system of the present invention shown in FIG. 2. The base plate assembly 24 is attached to the rear nacelle 56 and the forward nacelle 54 encases both the base plate assembly 24 and the rear nacelle 56. The base plate 58 is raised in the center and is designed to rotate around a central rotation axis.

In the preferred embodiment, a two dimensional potential flow investigation is performed to support the fluid dynamics mechanism. The results of the two dimensional potential flow investigation are provided to the duct analysis unit. Here, the plurality of ducts is assumed of having a diameter of one meter. In the preferred embodiment, the two dimensional potential flow investigation is conducted utilizing a Multi Element Airfoil (MEA) software. Preferably, the fluid dynamics mechanism may be an axisymmetric Computational Fluid dynamics (CFD). The CFD mechanism prepares a geometry test matrix in which different geometrical positions for the plurality of airfoils 20 are considered and a study is performed to determine the effect of the airfoil gap length and the airfoil overlap length between the plurality of airfoils 20. The fluid first passes through at least one of the plurality of expanding stages, producing more power and then passes through at least one of the plurality of contracting stages thereby obtaining the maximum power by utilizing the wind energy optimally.

In order to perform the two dimensional potential flow investigation, an inverted airfoil is chosen with a chord divergence angle of 10 degrees. In the preferred embodiment, the duct analysis unit is a two stage duct design having two symmetrically opposed airfoils. As is shown more detail in FIG. 8, the two stage axisymmetric duct system 10 with a first inverted airfoil 26 and a second inverted airfoil 28 is illustrated. The two stage duct system 10 analyzes the fluid mass flow rate through vanes or the plurality of airfoils 20 of the wind turbine. The first inverted airfoil 26 and the second inverted airfoil 28 have an airfoil gap length of “G” units length and an airfoil overlap length between the adjacent airfoils of “OL” units length. The airfoil chord angles of the first inverted airfoil 26 and the second inverted airfoil 28 are denoted by angle θ₁ and θ₂ respectively. The CFD mechanism for each geometry of the airfoil design is analyzed and the model notation for each geometry is given by a format [OL-G_θ₁-θ₂]. The CFD mechanism is applied on a freestream fluid velocity of 12 meters per second. The fluid mass flow rate through the airfoils 26, 28 during the analysis is assumed to be a turbulent incompressible flow employing a Renormalization Group (RNG) k-ε turbulence model with a characteristics turbulence intensity of one percentage.

TABLE 1

| | R₁ | R₂ | R₁ₜₕ | R₂ₜₕ | C₁ | C₂ | θ₁ | θ₂ | G | OL | S |
|---|---|---|---|---|---|---|---|---|---|---|---|
| Model | [m] | [m] | [m] | [m] | [m] | [m] | [deg] | [deg] | [% C₁] | [% C₁] | [% C₁] |
| [-30-10_10-10] | 1 | 1.074 | 0.962 | 1.036 | 1 | 1 | 10 | 10 | 10.00% | −30.00% | 15.10% |
| [-30-50_10-10] | 1 | 0.674 | 0.962 | 0.636 | 1 | 1 | 10 | 10 | 50.00% | −30.00% | 54.40% |
| [30-05_10-10] | 1 | 0.685 | 0.962 | 0.647 | 1 | 1 | 10 | 10 | 5.00% | 30.00% | 4.00% |
| 30-10_10-10] | 1 | 0.964 | 0.962 | 0.927 | 1 | 1 | 10 | 10 | 10.00% | 30.00% | 8.60% |
| [30-15_10-10] | 1 | 0.914 | 0.962 | 0.877 | 1 | 1 | 10 | 10 | 15.00% | 30.00% | 13.30% |
| [30-20_10-10] | 1 | 0.864 | 0.962 | 0.827 | 1 | 1 | 10 | 10 | 20.00% | 30.00% | 18.00% |
| [30-50_10-10] | 1 | 0.564 | 0.962 | 0.527 | 1 | 1 | 20 | 10 | 50.00% | 30.00% | 46.40% |
| [30-30_20-10] | 1 | 0.87 | 0.979 | 0.832 | 1 | 1 | 20 | 10 | 30.00% | 30.00% | 27.00% |
| [30-30_20-20] | 1 | 0.87 | 0.979 | 0.849 | 1 | 1 | 20.0 | 20 | 30.00% | 30.00% | 25.80% |
| [36-07_0-10] | 1 | 0.87 | 0.921 | 0.832 | 1 | 1 | 0 | 10 | 7.00% | 36.00% | 3.80% |
| [40-10_10-10] | 1 | 0.934 | 0.962 | 0.897 | 1 | 1 | 10.0 | 10 | 10.00% | 40.00% | 8.40% |
| [50-20_20-20] | 1 | 0.878 | 0.979 | 0.857 | 1 | 1 | 20 | 20 | 20.00% | 50.00% | 16.70% |

With reference to Table 1, the geometries of the airfoil designs to be examined are tabulated. Here, the different airfoil gap length and the airfoil overlap length between adjacent airfoils and airfoil chord angles of the pair of airfoils are set to determine the optimal airfoil arrangement of the airfoils. Here, for the sake of simplicity, a two stage duct design is assumed. In Table 1, R1, R2 shows the inlet radii of a first duct, duct 1, and a second duct which is duct 2. R1 and R2 denote throat radii of duct 1 and duct 2 respectively. C1 and C2 denote the chord lengths of duct 1 and duct 2 respectively. Here, “S” denotes the spacing between the adjacent airfoils.

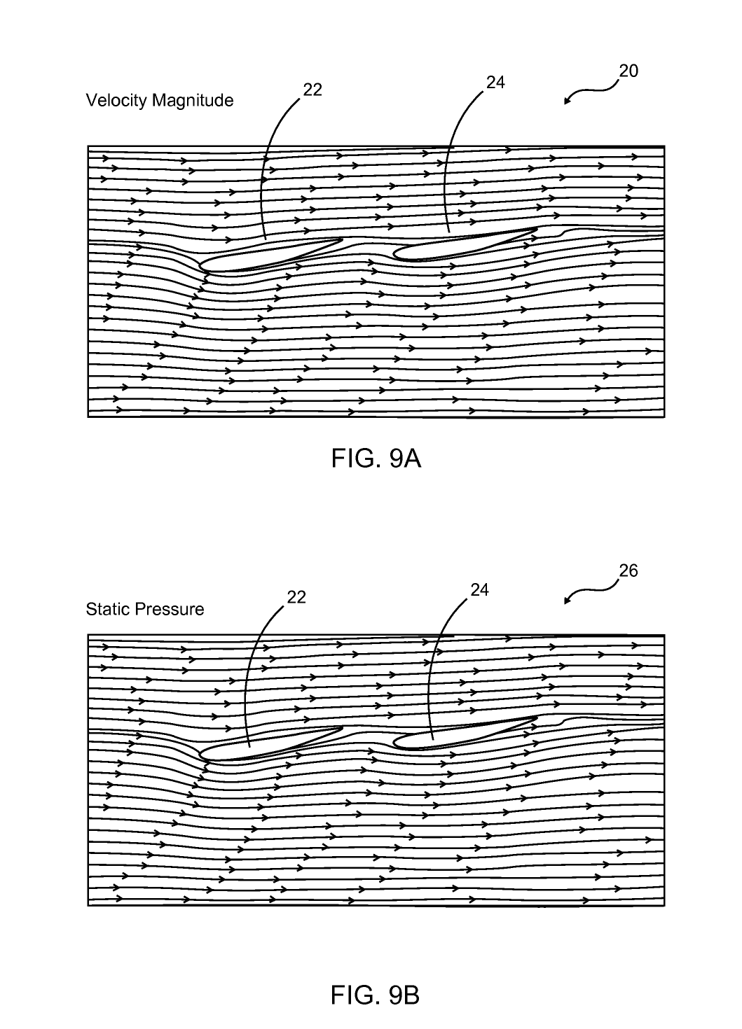

The velocity and static pressure contour plots for airfoil designs having models [−30-10 10-10], [−30-50 10-10], [30-05 10-10], [30-30_{—}20-10] and [50-20 20-20] are illustrated through FIGS. 9A-13B. Here, the velocity and static pressure contour plots overlaid with streamlines illustrate the fluid flow paths. FIG. 9A shows the velocity magnitude contour plot 34 of the fluid flow over a first airfoil 30 and a second airfoil 32. FIG. 9B illustrates the static pressure contour plot 36 of the fluid flow over the first airfoil 30 and the second airfoil 32. The first airfoil 30 and the second airfoil 32 have an airfoil overlap length of −30 units and an airfoil gap length of −10 units between them. The first airfoil 30 and the second airfoil 32 have a same airfoil chord angle of 10 degrees each. Utilizing the velocity distribution at a throat of each duct, the mass flow rate and the power available are calculated using equations:

$${\dot{m}}_{i} = \int {\int }_{{A}_{i}}^{ } ρ {U}_{i} d {A}_{i} = 2 πρ {\int }_{0}^{{R}_{i}} {U}_{i} ( r ) r d r$$

where \dot{m}ᵢ is mass flow rate of i^{th} duct, Aᵢ is throat area of i^{th} duct, ρ is air density, is velocity in throat of i^{th} duct, Rᵢ is throat radius of i^{th} duct
and

$${P}_{avail} = \frac{1}{2} \int {\int }_{Ai}^{ } ρ {U}_{i}^{3} d {A}_{i} = πρ {\int }_{0}^{{R}_{i}} {U}_{i}^{3} r d r$$

where Pₐᵥₐᵢₗ_{ᵢ} is power available in i^{th} duct.

A simple order of magnitude analysis employing a classical actuator disk theory provides insights into the relative improvements attributed to each duct.

Neglecting a wake rotation, the mechanical power exerted by the fluid on a wind turbine rotor becomes equivalent to the product of thrust and velocity as shown by the equation P_{disk}=TU.

In turn, the increase in mechanical power extraction is proportional to the increase in mass flow rate through the wind turbine rotor and is shown by the equation ΔP α U α^{rh}. By selecting a duct adaptable to maximize the mass flow rate passing through the duct/rotor system, the mechanical power extraction from the system 10 can be increased.

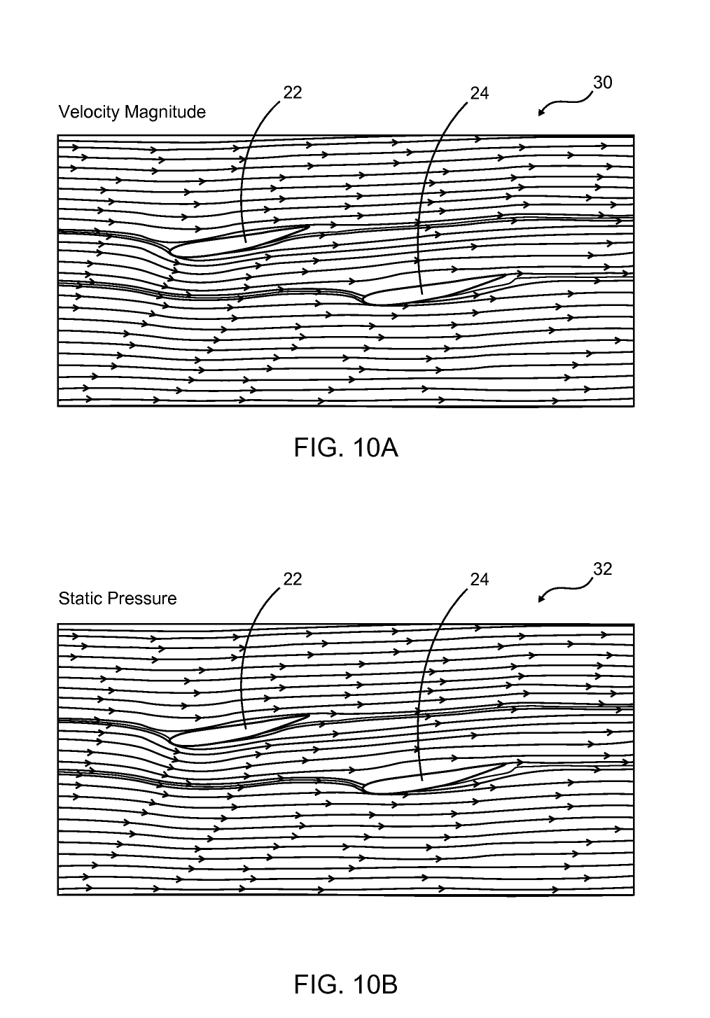

FIG. 10A shows the velocity magnitude contour plot 38 of the fluid flow over the first airfoil 30 and the second airfoil 32 for the airfoil design [30-50_{—}10-10]. FIG. 10B illustrates the static pressure contour plot 40 of the fluid flow over the first airfoil 30 and the second airfoil 32. The first airfoil 30 and the second airfoil 32 have an overlap length of −30 units and a gap length of 50 units between them. The first airfoil 30 and the second airfoil 32 have the same chord angle of 10 degrees each.

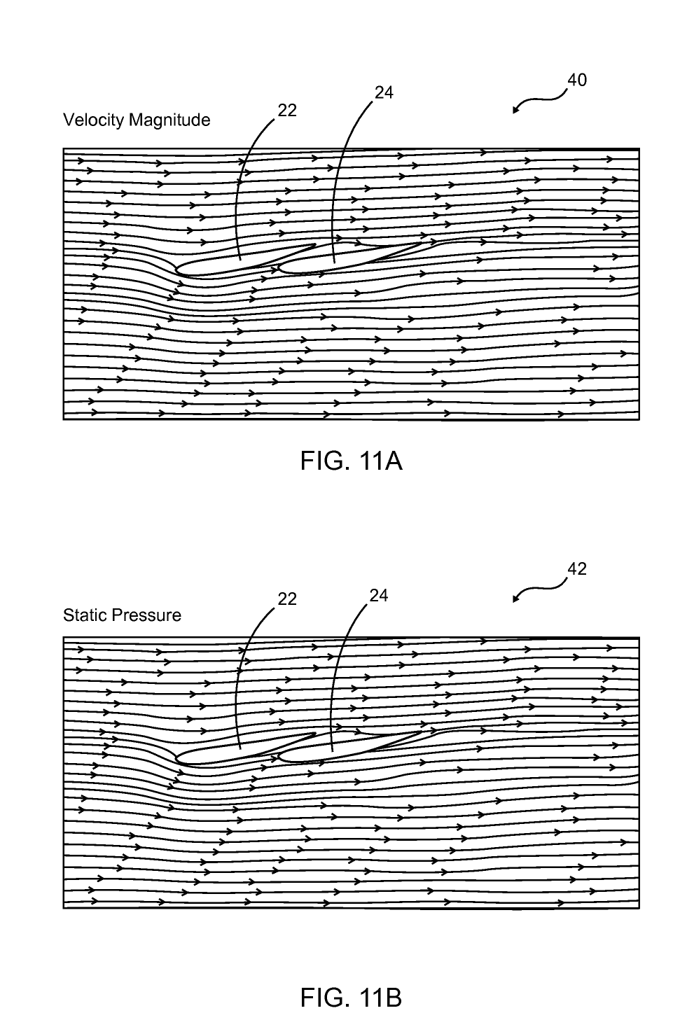

FIG. 11A shows the velocity magnitude contour plot 42 of the fluid flow over the first airfoil 30 and the second airfoil 32 for the airfoil design [30-05_{—}10-10]. FIG. 11B illustrates the static pressure contour plot 44 of the fluid flow over the first airfoil 30 and the second airfoil 32. The first airfoil 30 and the second airfoil 32 have an overlap length of 30 units and a gap length of 5 units between them. The first airfoil 30 and the second airfoil 32 have the same airfoil chord angle of 10 degrees each.

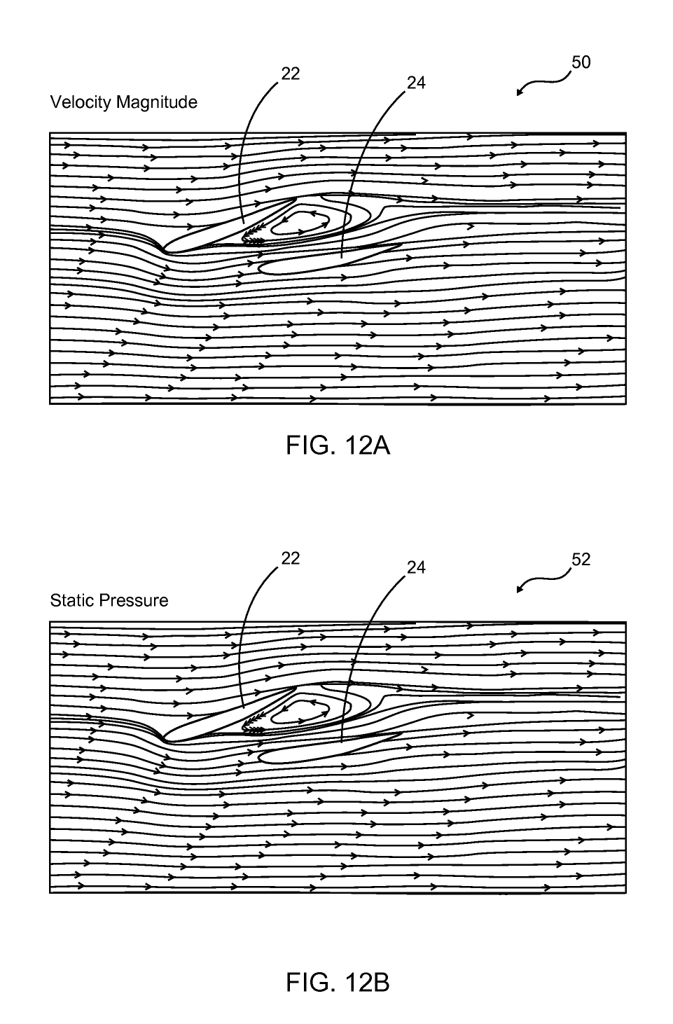

FIG. 12A shows the velocity magnitude contour plot 46 of the fluid flow over the first airfoil 30 and the second airfoil 32 for the airfoil design [30-30_{—}20-10]. FIG. 12B illustrates the static pressure contour plot 48 of the fluid flow over the first airfoil 30 and the second airfoil 32. The first airfoil 30 and the second airfoil 32 have an overlap length and a gap length of 30 units each. The first airfoil 30 has a chord angle of 20 degrees and the second airfoil 32 has a chord angle of 10 degrees.

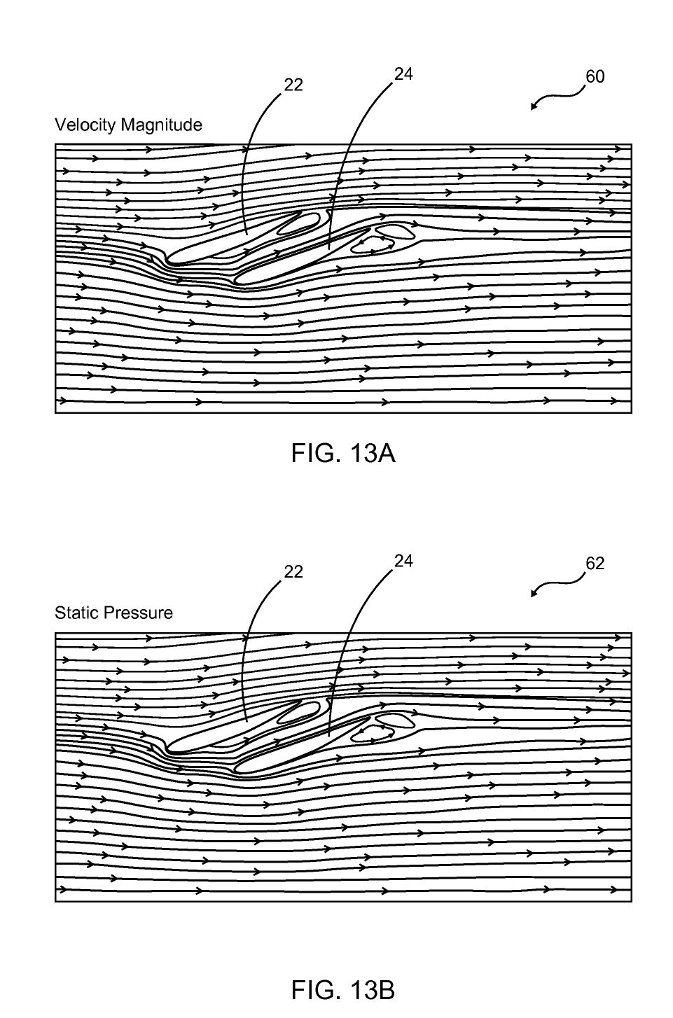

FIG. 13A shows the velocity magnitude contour 50 of the fluid flow over the first airfoil 30 and the second airfoil 32 for the airfoil design [50-20_{—}20-20]. FIG. 13B illustrates the static pressure contour plot 52 of the fluid flow over the first airfoil 30 and the second airfoil 32. The first airfoil 30 and the second airfoil 32 have an overlap length of 50 units and a gap length of 20 units. The first airfoil 30 and the second airfoil 32 have a chord angle of 20 degrees each.

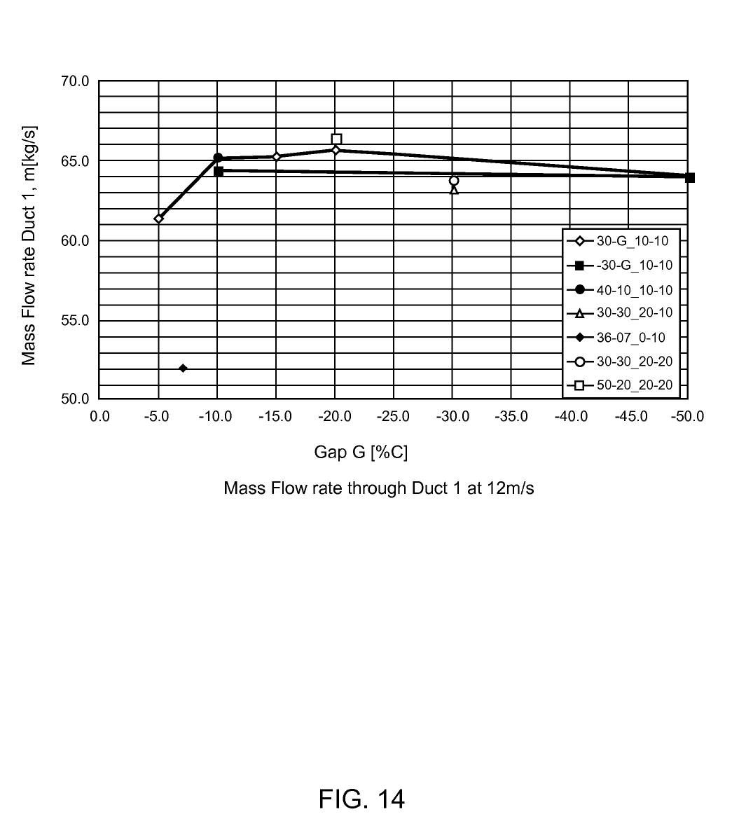

FIGS. 14-17 show the mass flow rate and power available in duct 1 and duct 2. Geometries with similar airfoil chord angle and airfoil overlap length are plotted on a single curve.

As is illustrated more clearly in FIG. 14, a graph in two dimensions representing the value of mass flow rate through duct 1 for the various airfoil gap lengths between the first airfoil 30 and the second airfoil 32 is illustrated. Here the turbulent incompressible fluid flow is assumed to have a freestream velocity of 12 m/s. From the graph it is clear that an airfoil gap length of 20 units and an airfoil overlap length of 50 units between the adjacent airfoils provide a maximum mass flow rate of more than 66 kg/s. All other airfoil designs provide less airflow compared to the above described design with the airfoil overlap length of 50 units, the airfoil gap length of 20 units between the first airfoil 30 and the second airfoil 32 and an airfoil chord angle of 20 degrees each.

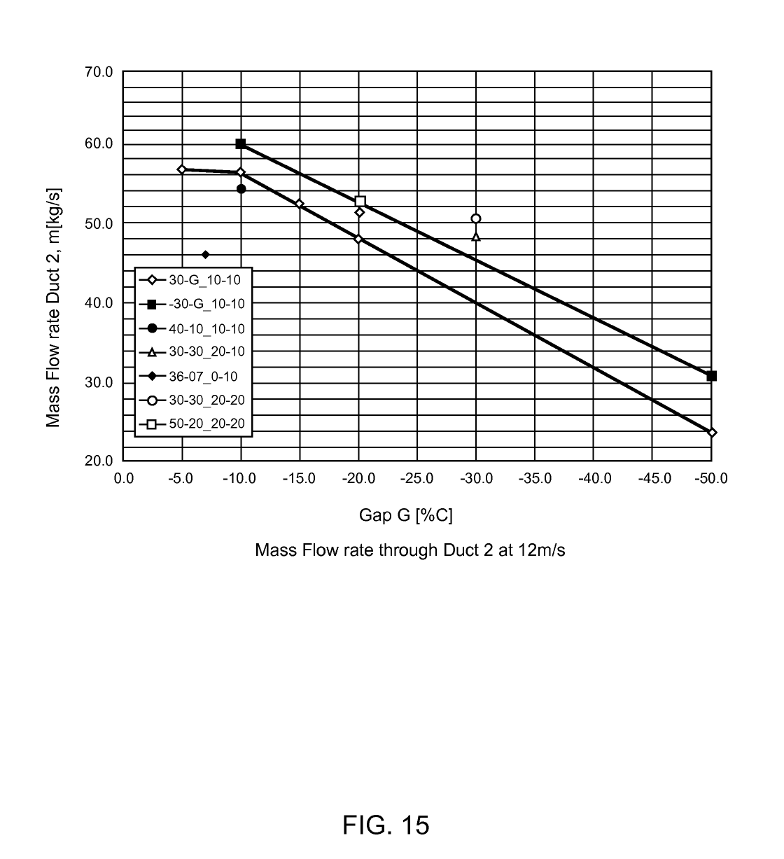

FIG. 15 illustrates a graph in two dimensions representing the value of mass flow rate through duct 2 according to the preferred embodiment for the various airfoil gap lengths between the first airfoil 30 and the second airfoil 32. Apparently, an airfoil overlap length of 30 units and an airfoil gap length of −10 units between the adjacent airfoils provide a maximum fluid mass flow rate of more than 65 kg/s. All other blade angle design models or the airfoil designs provide less airflow compared to the above described design with an airfoil overlap length 20 units between the first airfoil 30 and the second airfoil 32 and an airfoil chord angle of 20 degrees each. The airfoil designs with an airfoil overlap length of 50 units and an airfoil gap length of 20 units with an airfoil chord angle of 20 degrees each, the mass flow rate obtained is around 56 kg/s. The mass flow rate for the second duct, d2 is lower for the airfoil design [50-20_{—}20-20] compared to the fluid mass flow rate through the first duct, duct 1 which is approximately 66 kg/s. With the freestream fluid velocity of 12 m/s, the maximum mass is obtained for the design [−30-10_{—}10-10] at the second duct, duct 2. But as the airfoil gap length between the airfoils increases the mass flow rate reduces at a constant rate.

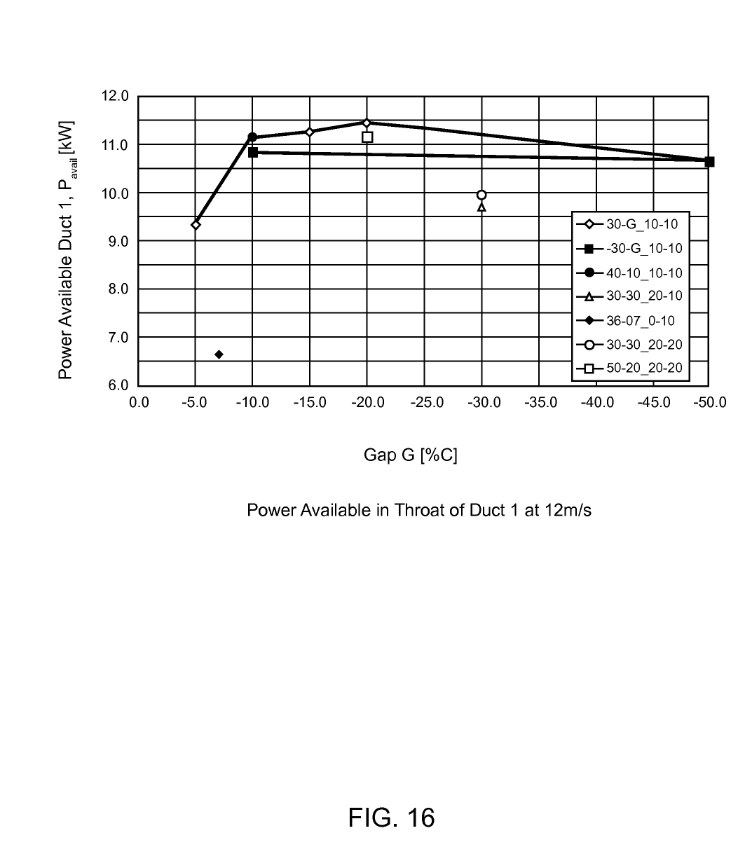

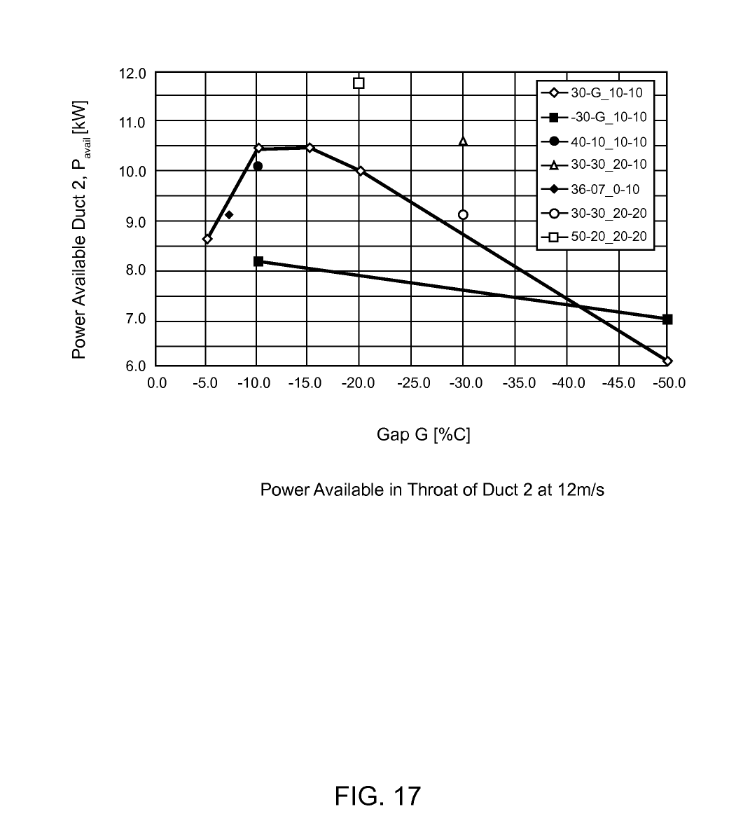

FIG. 16 illustrates a graph in two dimensions representing the value of power available at the throat of duct 1 in KW units for various airfoil gap lengths between the first airfoil 30 and the second airfoil 32. FIG. 17 illustrates a graph in two dimensions representing the value of power available at the throat of duct 2 in KW units for the various gap lengths between the first airfoil 30 and the second airfoil 32. By analyzing FIG. 16 and FIG. 17, it is clear that the airfoil design [50-20_{—}20-20] provides a maximum power output of more than 10 KW at both the first duct and the second duct. The airfoil design [30-G_{—}10-10] illustrated in FIG. 16 provides a maximum power output of 11.5 KW with the airfoil gap length of 20 units. But this power output is limited to the first duct, duct 1, alone. The airfoil design [30-G_{—}10-10] illustrated in FIG. 17 provides a power output of around 10 KW with the gap length of 20 units at duct 2 which is lower when compared to the power output of nearly 12 KW generated by the airfoil design [50-20_{—}20-20].

Hence, from the above analysis, it is clear that in order to obtain the optimal mass flow rate through the airfoils and to obtain maximum power from the wind turbine having the dual staged duct design, the design of airfoils should be [50-20_{—}20-20], i.e. an airfoil overlap length of 50 units and an airfoil gap length of 20 units between the adjacent airfoils and an airfoil chord angle of 20 degrees for each airfoil.

As shown in FIGS. 14-17, the optimal airfoil arrangement providing the maximum fluid mass flow rate is found to be [50-20_{—}20-20]. The increased airfoil chord angles yield more diffusion, however for airfoil arrangement with large gaps and spacing. The viscosity of the air has a tendency to induce separation thereby trashing any performance gains. By providing a large value for the airfoil overlap length and a small value for the airfoil gap length, the flow is less prone to separation through the bypass providing more efficient diffusion and an increased fluid mass flow rate. Hence a multi staged duct design is recommended to employ proper arrangement of bypass and bleed-off channels to maximize the efficient diffusion of the air flow within the duct. An investigation into off-axis flows is also required to determine yaw and up flow/down flow performance issues.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A multi-stage duct system for use in a wind turbine comprising:
a plurality of wind turbine units, each of the plurality of wind turbine units comprising:
a plurality of turbine rings secured in a nacelle of the wind turbine, the plurality of turbine rings defines to form a plurality of expanding stages and a plurality of contracting stages positioned in-line with a fluid flow direction;
a plurality of airfoils arranged in the plurality of expanding stages and in the plurality of contracting stages;
a magnetic mechanism located at the plurality of turbine rings; and
a duct analysis unit having a plurality of axisymmetric ducts, the duct analysis unit utilizes a fluid dynamics mechanism to provide an optimal airfoil arrangement to the plurality of airfoils for optimizing a plurality of airfoil parameters associated with each of the plurality of airfoils thereby providing an efficient diffusion and an optimal fluid mass flow rate through the plurality of airfoils;
whereby the magnetic mechanism and the optimal airfoil arrangement of the plurality of airfoils enable the duct analysis unit to generate a maximum power from the wind turbine.

2. The multi-stage duct system of claim 1 wherein the plurality of airfoil parameters includes an airfoil overlap length, an airfoil gap length and an airfoil chord angle.

3. The multi-stage duct system of claim 1 wherein the optimal airfoil arrangement compresses the fluid flow through the plurality of expanding stages and the plurality of contracting stages to increase the fluid mass flow rate.

4. The multi-stage duct system of claim 1 wherein the plurality of turbine rings is designed to rotate around a central rotation axis and is secured inside a nacelle of the wind turbine.

5. The multi-stage duct system of claim 1 wherein the magnetic mechanism includes a plurality of permanent magnet alternators (PMAs) adaptable to generate a maximum power from the wind turbine.

6. The multi-stage duct system of claim 1 wherein the fluid dynamics mechanism creates a geometry matrix to provide different geometrical positions to the plurality of airfoils, the geometric matrix determines an optimum effect of the airfoil gap length and the airfoil overlap length between the plurality of airfoils.

7. The multi-stage duct system of claim 1 wherein the optimum fluid mass flow rate is given by
$${\dot{m}}_{i} = \int {\int }_{{A}_{i}}^{ } ρ {U}_{i} d {A}_{i} = 2 πρ {\int }_{0}^{{R}_{i}} {U}_{i} ( r ) r d r ,$$
where \dot{m}ᵢ is mass flow rate of i^{th} duct, Aᵢ is throat area of i^{th} duct, ρ is air density, Uᵢ is velocity in throat of i^{th} duct, Rᵢ is throat radius of i^{th} duct.

8. The multi-stage duct system of claim 1 wherein the maximum power generated from the wind turbine is given by
$${P}_{{avail}_{i}} = \frac{1}{2} \int {\int }_{{A}_{i}}^{ } ρ {U}_{i}^{3} d {A}_{i} = πρ {{\int }_{0}^{{R}_{i}}}_{ } {U}_{i}^{3} r d r ,$$
where Pₐᵥₐᵢₗ_{ᵢ} is power available in i^{th} duct.

9. The multi-stage duct system of claim 1 wherein the fluid dynamics mechanism is adaptable to increase the airfoil overlap length and decrease the airfoil gap length to obtain the efficient diffusion and the optimal fluid mass flow rate.

10. A multi-stage duct system for use in a wind turbine comprising:
a plurality of wind turbine units rotatable around a central rotation axis, each of the plurality of wind turbine units comprising:
a plurality of turbine rings secured in a nacelle of the wind turbine, the plurality of turbine rings defines to form a plurality of expanding stages and a plurality of contracting stages positioned in-line with a fluid flow direction;
a plurality of airfoils arranged in the plurality of expanding stages and in the plurality of contracting stages;
a magnetic mechanism located at the plurality of turbine rings, the magnetic mechanism includes a plurality of permanent magnet alternators (PMAs) to generate a maximum power from the wind turbine; and
a duct analysis unit having a plurality of axisymmetric ducts, the duct analysis unit utilizes a fluid dynamics mechanism to provide an optimal airfoil arrangement to the plurality of airfoils for optimizing an airfoil overlap length, an airfoil gap length and an airfoil chord angle of the plurality of airfoils thereby providing an efficient diffusion and an optimal fluid mass flow rate through the plurality of airfoils;
whereby the magnetic mechanism and the optimal airfoil arrangement of the plurality of airfoils enable the duct analysis unit to generate a maximum power from the wind turbine.

11. The multi-stage duct system of claim 10 wherein the optimal airfoil arrangement compresses the fluid flow through the plurality of expanding stages and the plurality of contracting stages to increase the fluid mass flow rate.

12. The multi-stage duct system of claim 10 wherein the fluid dynamics mechanism creates a geometry matrix to provide different geometrical positions for the plurality of airfoils to determine an optimum effect of the airfoil gap length and the airfoil overlap length between the plurality of airfoils.

13. The multi-stage duct system of claim 10 wherein the magnetic mechanism includes a plurality of permanent magnet alternators (PMAs) adaptable to generate a maximum power from the wind turbine.

14. The multi-stage duct system of claim 10 wherein the optimum fluid mass flow rate is given by
$${\dot{m}}_{i} = \int {\int }_{{A}_{i}}^{ } ρ {U}_{i} d {A}_{i} = 2 πρ {\int }_{0}^{{R}_{i}} {U}_{i} ( r ) d r .$$
where \dot{m}ᵢ is mass flow rate of i^{th} duct, Aᵢ is throat area of i^{th} duct, ρ is air density, Uᵢ is velocity in throat of i^{th} duct, Rᵢ is throat radius of i^{th} duct.

15. The multi-stage duct system of claim 10 wherein the maximum power generated from the wind turbine is given by
$${P}_{{avail}_{i}} = \frac{1}{2} \int {\int }_{{A}_{i}}^{ } ρ {U}_{i}^{3} d {A}_{i} = πρ {\int }_{0}^{{R}_{i}} {U}_{i }^{3} r d r ,$$
where Pₐᵥₐᵢₗ_{ᵢ} is power available in i^{th} duct.

16. The multi-stage duct system of claim 10 wherein the fluid dynamics mechanism is adaptable to increase the airfoil overlap length and decrease the airfoil gap length to obtain the efficient diffusion and the optimal fluid mass flow rate.

17. A method for optimizing a fluid mass flow rate in a multi-stage duct system of a wind turbine, the method comprising:
(a) providing a plurality of wind turbine units adaptable to rotate around a central axis;
(b) providing a plurality of turbine rings secured in a nacelle of the wind turbine, the plurality of turbine rings defines to form a plurality of expanding stages and a plurality of contracting stages;
(c) implementing a magnetic mechanism in the plurality of turbine rings;
(d) providing an optimal airfoil arrangement to the plurality of airfoils utilizing a duct analysis unit and a fluid dynamics mechanism;
(e) optimizing a plurality of airfoil parameters; and
(f) compressing the fluid flow through the plurality of expanding stages and the plurality of contracting stages to obtain an efficient diffusion and an optimal fluid mass flow rate.

18. The method of claim 17 wherein the plurality of airfoil parameters includes an airfoil overlap length, an airfoil gap length and an airfoil chord angle.

19. The method of claim 17 wherein the optimum fluid mass flow rate is given by
$${\dot{m}}_{i} = \int {\int }_{{A}_{i}}^{ } ρ {U}_{i} d {A}_{i} = 2 πρ {\int }_{0}^{{R}_{i}} {U}_{i} ( r ) d r .$$
where \dot{m}ᵢ is mass flow rate of i^{th} duct, Aᵢ is throat area of i^{th} duct, ρ is air density, Uᵢ is velocity in throat of i^{th} duct, Rᵢ is throat radius of i^{th} duct.

20. The method of claim 17 wherein the maximum power generated from the wind turbine is given by
$${P}_{{avail}_{i}} = \frac{1}{2} \int {\int }_{{A}_{i}}^{ } ρ {U}_{i}^{3} d {A}_{i} = πρ {\int }_{0}^{{R}_{i}} {U}_{i}^{3} r d r ,$$
where Pₐᵥₐᵢₗ_{ᵢ} is power available in i^{th} duct.
